(19) United States
(12) Patent Application Publication
(10) Pub. No.: US 2014/0182122 A1
(43) Pub. Date: Jul. 3, 2014

(54) ASSEMBLER MECHANISM

(71) Applicants: HON HAI PRECISION INDUSTRY CO., LTD., New Taipei (TW); FU DING ELECTRONICAL TECHNOLOGY (JIASHAN) CO.,LTD., Zhejiang (CN)

(72) Inventor: XIAO-LU OU, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/138,319

(22) Filed: Dec. 23, 2013

(30) Foreign Application Priority Data
Dec. 28, 2012 (CN) 2012207380652

(51) Int. Cl. B23P 19/04

(52) U.S. Cl. CPC B23P 19/04
USPC 29/771

(57) ABSTRACT

An assembler mechanism for picking up and presenting one workpiece to another for precise bonding notwithstanding the motions of transportation includes a support seat, a first picking member, a first driving member, a second picking member, and a positioning assembly. The first picking member is mounted on the support seat and fetches a first workpiece when driven by the first driving member. The second picking member is connected to and also driven by the first driving member to fetch a second workpiece. The positioning assembly is mounted on the support seat, and includes a positioning member, a movable member located corresponding to the positioning member, and a second driving member connected to the movable member. The movable member can be driven by the second driving member toward or away from the positioning member to achieve unvarying and stable presentations.

### BACKGROUND

1. Technical Field

The present disclosure generally relates to assembler mechanisms, and particularly to an assembler mechanism for assembling two workpieces together during a welding process.

2. Description of the Related Art

In a production process, a first workpiece may be bonded to a second workpiece, and then the two bonded workpieces are moved. For improving work efficiency, a robot equipped with an assembler mechanism is used to fetch the first workpiece and bond the first workpiece to the second workpiece. However, when moving the first workpiece, the assembler mechanism may shake or change position slightly, thus a bonding position of the first workpiece and the second workpiece may deviate from a predetermined position. A quality of the bonding may thus be adversely affected.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an assembled, isometric view of an embodiment of an assembler mechanism.

FIG. 2 is similar to FIG. 1, but viewed from another aspect.

FIG. 3 shows a partial and exploded view of the assembler mechanism of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

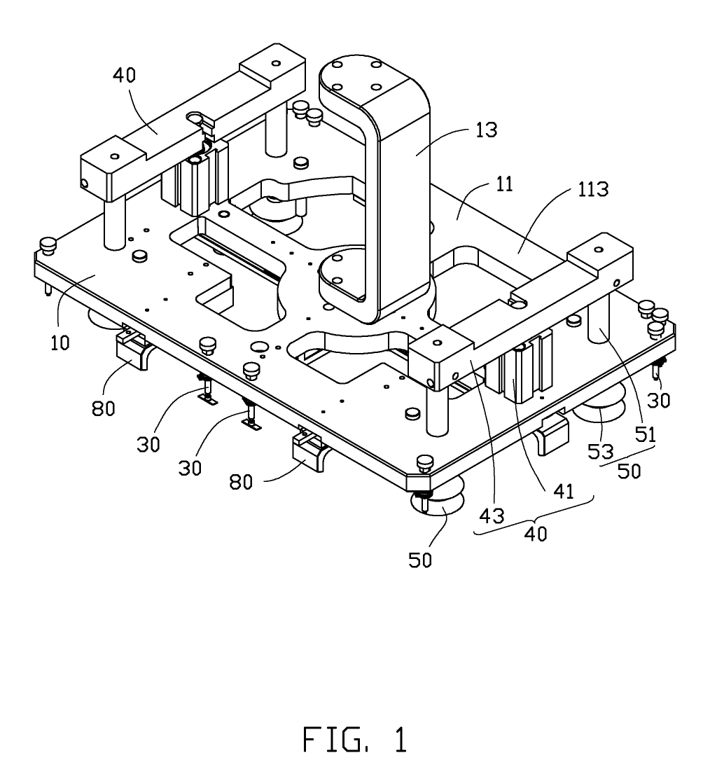

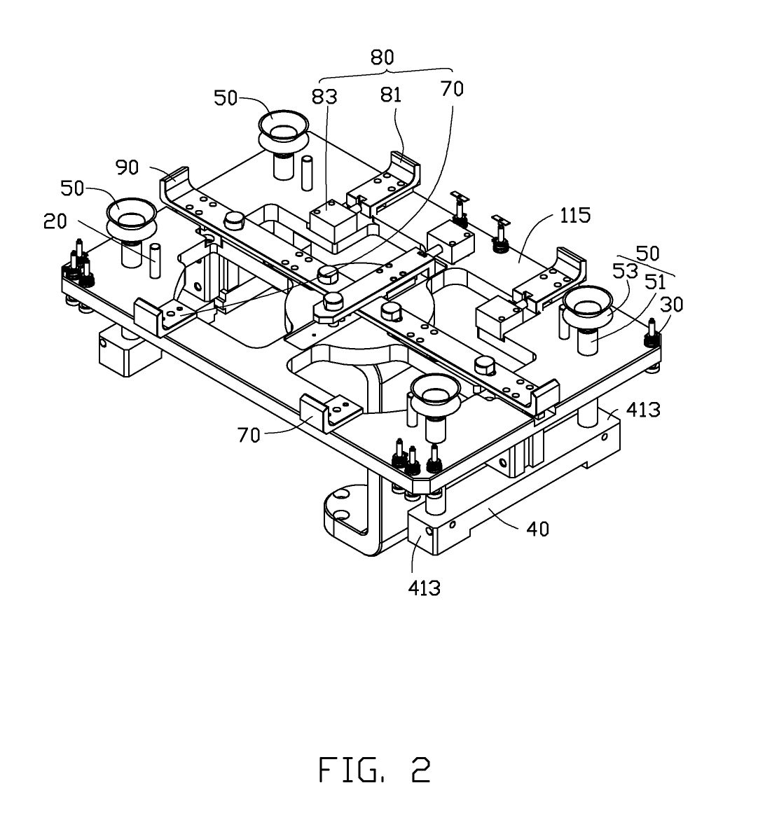

FIGS. 1 through 3 show an assembler mechanism 100, which is applied for fetching a first workpiece (not shown) and a second workpiece (not shown) and bonding the first workpiece to the second workpiece. The assembler mechanism 100 includes a support seat 10, a plurality of first picking members 30, two driving members 40, four second picking members 50, two positioning assemblies 80, and a limiting assembly 90. The first picking members 30 are mounted on the support seat 10, for picking the first workpieces. The two driving members 40 are mounted on opposite end portions of the support seat 10. Each of the two second picking members 50 is connected to and driven by one driving member 40, and passes through the support seat 10, for picking the second workpiece. The two positioning assemblies 80 are located on sides of the support seat 10. The limiting assembly 90 is located on a middle portion of the support seat 10. The positioning assemblies 80 are configured to position the second workpiece along a first direction. The limiting assembly 90 is configured to position the second workpiece along a second direction.

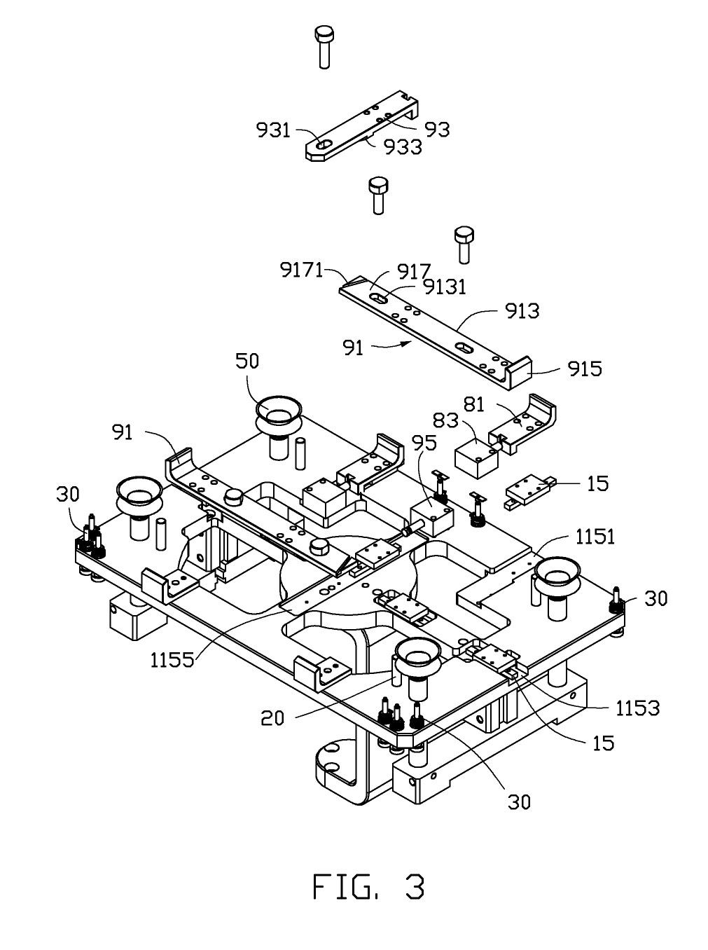

The support seat 10 includes a support base 11, a connection member 13, and a plurality of guiding rails 15. The support base 11 is a substantially rectangular plate, and includes a first support surface 113 and a second support surface 115 opposite to the first support surface 113. The connection member 13 is securely mounted on the first support surface 113. The second support surface 115 defines two first mounting slots 1151 adjacent to one side thereof (shown in FIG. 3). The two first mounting slots 1151 are substantially parallel to and spaced from each other. The second support surface 115 further defines a second mounting slot 1153 substantially perpendicular to the first mounting slots 1151 and a third mounting slot 1155 crosses with the second mounting slot 1153 in a middle portion thereof. One guiding rail 15 is mounted in each of the first mounting slots 1151, in the second mounting slot 1153, and in the third mounting slot 1155. The first picking members 30 are mounted on the support base 11 spaced from each other and protruding from the second support surface 115.

The two driving members 40 are securely mounted on opposite end portions of the first support surface 113. Each driving member 40 includes a main body 41 and a driving portion 43 connected to the main body 41. The main body 41 is securely mounted on the first support surface 113. A middle portion of the driving portion 43 is connected to and driven by the main body 41. The driving portion 43 includes two mounting end portions 431 opposite to each other.

Each second picking member 50 is mounted on one mounting end portion 431 of the two driving members 40, and passes through the support seat 10 and protrudes out from the second support surface 115. Each second picking member 50 includes a connection portion 51 and a suction portion 53 connected to the connection portion 51. The connection portion 51 passes through the support base 11 and is movable therein. One end portion of the connection portion 51 is connected to the mounting end portion 431, and the other end portion of the connection portion 51 is connected to the suction portion 53, such that the connection portion 51 and the suction portion 53 are movable relative to the support base 11 when driven by the corresponding driving member 40. When the first picking member 30 is in an original state, a distance from a free end of the first picking member 30 to the support base 11 is greater than a distance from a free end of the suction portion 53 to the support base 11, such that when the first picking members 30 fetches the first workpiece, the second picking members 50 may not intervene.

In an illustrated embodiment, the connection portion 51 is hollow and substantially cylindrical, and connected to a vacuum generator (not shown), such that the second workpiece can be picked up and released by the suction portion 53. In other embodiments, the second picking members 50 can be in other structures according to the second workpiece.

The two positioning assemblies 80 are located on the second supporting surface 115 side by side. Each of the positioning assemblies 80 includes a positioning member 70, a movable member 81, and a driving member 83. The positioning members 70 are mounted on the second support surface 115, each corresponding to the two first mounting slots 1151. The movable member 81 is connected to the guiding rail 15 in the first mounting slot 1151. The driving member 83 is mounted on the second support surface 115, for driving a movable member 81 to slide along the guiding rail 15 in the first mounting slot 1151 toward or away from the positioning member 70.

The limiting assembly 90 includes two limiting members 91, a pushing member 93, a driving member 95, and a plurality of locking members 97. The two limiting members 91 are mounted on two guiding rails 15 in the second mounting slot 1153, and aligned in one straight line. Each limiting member 91 includes a main body 913, a limiting end 915, and a pushing end 917. The main body 913 is securely mounted on the second support surface 115, and defines a sliding through slot 9131. The limiting end 915 bends through substantially ninety degrees from one end portion of the main body 913. The pushing end 917 is formed on the other end portion of the main body 913 opposite to the limiting end 915. The pushing end 917 defines a first sliding portion 9171. The pushing member 93 is slidably mounted on one guiding rail 15 in the third mounting slot 1155. The pushing member 93 defines a sliding through slot 931. The pushing member 93 includes two second sliding portion 933 engaged with the first sliding portions 9171 of the two limiting members 91.

In the illustrated embodiment, the first sliding portion 9171 is an oblique sliding groove in the pushing end 917 and the second sliding portion 933 is a protrusion engaged with the oblique sliding groove. In other embodiments, the first sliding portion 9171 can also be arc-shaped groove. The driving member 95 is fixedly mounted on the second support surface 115 away from the positioning member 70, and is connected to the pushing member 93. When the driving member 95 drives the pushing member 93, the two limiting members 91 move toward or away from each other. Each locking member 97 passes through one of the sliding slots 9131 and the sliding through slots 931, and is securely connected to the support base 11.

The assembler mechanism 100 further includes four blocking members 20. Each blocking member 20 is mounted on the second support surface 115 adjacent to one of the four second picking members 50.

In assembly, the first picking members 30 are mounted on the support base 11 according to the positions required for the welding of the second workpiece. The two driving members 40 are mounted on opposite end portions of the first support surface 113. Each two second picking members 50 are mounted on opposite mounting end portions 431 of one driving member 40. The two positioning members 70 are mounted on the second support surface 115. Each movable member 81 is slidably mounted on the guiding rail 15 in the first mounting slot 1151, and each driving member 83 is mounted on the second support surface 115 and connected to a movable member 81. Two limiting members 91 are slidably mounted on the guiding rail 15 in the second mounting slot 1153, and the pushing ends 917 of the two limiting members 91 are adjacent to each other. The pushing member 93 is slidably mounted on the guiding rail 15 in the third mounting slot 1153 and crossed with the two limiting members 91, such that the two second sliding portion 933 are engaged with the first sliding portions 9171 of the two limiting members 91. One end portion of the connection member 13 away from the support base 11 is fixed to a robot arm (not shown).

In use, first, the first picking member 30 picks up a first workpiece. The second picking members 50 are moved to and pick up a second workpiece, and then are stopped by the blocking member 20. The two positioning members 70 resist against opposite sides of the second workpiece, the first workpiece contacts a surface of the second workpiece. The movable members 81 are moved toward the positioning members 70, and the two limiting members 91 are moved toward each other, such that the second workpiece is positioned along two directions. Then, the assembler mechanism 100 is moved to a laser station, for example, for the robot arm to weld the first workpiece to the second workpiece.

The positioning assemblies 80 and the limiting assembly 90 can cooperatively position the first workpiece and the second workpiece, such that during motion of the assembler mechanism 100, the first workpiece will not deviate from the second workpiece. Thus, a welding quality and yield is improved.

In other embodiments, the first mounting slots 1151, the second mounting slot 1153, and the third mounting slot 1155 can be omitted, and the guiding rails 15 can be directly mounted on the support base 11. A number of the driving members 40 and the second picking members 50 can be changed as needed, and the position of the driving members 40 can be changed as needed. The positioning assemblies 80 can be omitted, and the second workpiece can be positioned by the limiting assembly 90. The limiting assembly 90 can be omitted, and the second workpiece can be positioned by the positioning assemblies 80.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. An assembler mechanism comprising:
a support seat;
a first picking member mounted on the support seat and configured to fetch a first workpiece;
a first driving member mounted on the support seat;
a second picking member received through the support seat and configured to fetch a second workpiece, the second picking member being connected to and driven by the first driving member; and
a limiting assembly comprising:
two limiting members adjacent to each other, the two limiting members and the first picking member being mounted on the support seat on a same side, each of the two limiting members comprising a first sliding portion at one end portion, the first sliding portions of the two limiting members being adjacent to each other,
a second driving member, and
a pushing member connected to and driven by the second driving member, the pushing member comprising two second sliding portions each engaged with each of the first sliding portion so that the pushing member is adapted to moving the two limiting members toward or away from each other, wherein after the first picking member fetches the first workpiece, the second picking member moves relative to the support seat to fetch the second workpiece until the first and the second workpieces are in contact with each other, and then the two limiting members are moved toward each other to position the second workpiece.

2. The assembler mechanism of claim 1, wherein each of the two limiting members comprises a main body, a limiting end, and a pushing end, the main body is mounted on the support seat, the limiting end bends from one end portion of the main body and is located adjacent to and at an edge from the support seat, two limiting ends of the two limiting members are located at opposite ends of the support seat, the pushing end comprises the first sliding portion, the pushing ends of the two limiting members are located adjacent to each other.

3. The assembler mechanism of claim 2, wherein the main body defines a sliding through slot, the limiting assembly further comprises a locking member, the locking member passes through the sliding through slot and is connected to the support seat.

4. The assembler mechanism of claim 2, wherein the pushing member defines a sliding through slot, the limiting assembly further comprises a locking member, the locking member passes through the sliding through slot and is connected to the support seat.

5. The assembler mechanism of claim 1, wherein the assembler mechanism further comprises a positioning assembly mounted on the support seat, the positioning assembly comprises a positioning member crossed with the two limiting members, a movable member, and a third driving member connected to the movable member, the positioning member is located corresponding to the movable member, the movable member is driven by the third driving member to move toward or away from the positioning member.

6. The assembler mechanism of claim 1, wherein the second picking member comprises a connection portion received through the support seat and a suction portion connected to the connection portion, the suction portion and the first picking member are spaced from each other and at a same side of the support seat.

7. The assembler mechanism of claim 6, wherein when the first picking member is in an original state, a distance from a free end of the first picking member to the support seat is greater than a distance from a free end of the suction portion to the support seat.

8. The assembler mechanism of claim 1, wherein the support seat comprises a support base and at least one guiding rail, the at least one guiding rail is mounted on the support base, the two limiting members and the pushing member are slidably mounted on the at least one guiding rail.

9. An assembler mechanism, comprising:
a support seat;
a first picking member mounted on the support seat and configured to fetch a first workpiece;
a first driving member mounted on the support seat;
a second picking member received through the support seat and configured to fetch a second workpiece, the second picking member being connected to and driven by the first driving member; and
a positioning assembly mounted on the support seat, the positioning assembly comprising:
a positioning member,
a movable member correspondingly located relative to the positioning member, and
a second driving member connected to the movable member, wherein the movable member is driven by the second driving member to move toward or away from the positioning member.

10. The assembler mechanism of claim 9, wherein the second picking member comprises a connection portion received through the support seat and a suction portion connected to the connection portion, the suction portion and the first picking member are spaced from each other and at a same side of the support seat.

11. The assembler mechanism of claim 10, wherein when the first picking member is in an original state, a distance from a free end of the first picking member to the support seat is greater than a distance from a free end of the suction portion to the support seat.

12. The assembler mechanism of claim 9, wherein the support seat comprises a support base and a guiding rail, the guiding rail is mounted on the support base, the movable member is slidably mounted on the guiding rail.

13. An assembler mechanism, the assembler mechanism comprising:
a support seat comprising a support base and at least one guiding rail, the at least one guiding rail being mounted on the support base;
a first picking member mounted on the support base and configured to fetch a first workpiece;
a first driving member mounted on the support base;
a second picking member received through the support base and configured to fetch a second workpiece, the second picking member being connected to and driven by the first driving member;
a limiting assembly comprising:
two limiting members adjacent to each other, the two limiting members and the first picking member being mounted on a same side of the support base, each of the two limiting members comprising a first sliding portion at one end portion, the first sliding portions of the two limiting members being adjacent to each other,
a second driving member, and
a pushing member connected to and driven by the second driving member, the pushing member comprising two second sliding portions engaged with the two first sliding portions so that the pushing member is adapted to moving the two limiting members toward or away from each other; and
a positioning assembly mounted on the support base, the positioning assembly comprising:
a positioning member crossed with the two limiting members,
a movable member, and
a third driving member connected to the movable member,
wherein the two limiting members, the pushing member, and the movable member are slidably mounted on the at least one guiding rail; after the first picking member fetches the first workpiece, the second picking member moves relative to the support base to fetch the second workpiece until the first and the second workpieces are in contact with each other, and then the movable member is driven by the third driving member to move toward or away from the positioning member, the two limiting members are moved toward each other to position the second workpiece.

14. The assembler mechanism of claim 13, wherein each of the two limiting members comprises a main body, a limiting end, and a pushing end, the main body is mounted on the support seat, the limiting end bends from one end portion of the main body and is located adjacent to and at an edge from the support seat, two limiting ends of the two limiting members are located at opposite ends of the support seat, the pushing end comprises the first sliding portion, two pushing ends of the two limiting members are located adjacent to each other.

15. The assembler mechanism of claim 14, wherein the main body defines a sliding through slot, the limiting assembly further comprises a locking member, the locking member passes through the sliding through slot and is connected to the support seat.

16. The assembler mechanism of claim 14, wherein the pushing member defines a sliding through slot, the limiting assembly further comprises a locking member, the locking member passes through the sliding through slot and is connected to the support seat.

17. The assembler mechanism of claim 13, wherein the second picking member comprises a connection portion received through the support seat and a suction portion connected to the connection portion, the suction portion and the first picking member are located spaced from each other and at a same side of the support seat.

18. The assembler mechanism of claim 17, wherein when the first picking member is in an original state, a distance from a free end of the first picking member to the support seat is greater than a distance from a free end of the suction portion to the support seat.

19. The assembler mechanism of claim 13, wherein the first sliding portion defines an oblique sliding groove, the second sliding portion comprises a protrusion engaged with the oblique sliding groove.

20. The assembler mechanism of claim 13, further comprising a blocking member located on the support base adjacent to the second picking member.
